(19) United States
(12) Patent Application Publication
(10) Pub. No.: US 2010/0232521 A1
(43) Pub. Date: Sep. 16, 2010

(54) Systems, Methods, and Media for Providing Interactive Video Using Scalable Video Coding

(76) Inventors: Pierre Hagendorf, Raanana (IL); Sagee Ben-Zedeff, Givatayim (IL)

Correspondence Address: Byrne Poh LLP, 11 Broadway, Ste 865, New York, NY, 10004, US

(21) Appl. No.: 12/761,885

(22) Filed: Apr. 16, 2010

Related U.S. Application Data
(63) Continuation-in-part of application No. 12/170,674, filed on Jul. 10, 2008.

(51) Int. Cl. H04N 7/26

(52) U.S. Cl. 375/240.26; 375/E07.078

(57) ABSTRACT

Systems for providing interactive video using scalable video coding comprise: at least one microprocessor programmed to at least: provide at least one scalable video coding capable encoder that at least: receives at least a base content sequence and a plurality of mutually exclusive added content sequences that have different content from the base content sequence; produces a first scalable video coding compliant stream that includes at least a basic layer, that corresponds to the base content sequence, and a first mutually exclusive enhancement layer, that corresponds to content in a first of the plurality of mutually exclusive added content sequences; and produces at least a second mutually exclusive enhancement layer, that corresponds to content in a second of the plurality of mutually exclusive added content sequences; and perform multiplexing of the first scalable video coding compliant stream and the second mutually exclusive enhancement layer to provide a second stream.

### CROSS REFERENCE TO RELATED APPLICATION

This application is a continuation-in-part of U.S. patent application Ser. No. 12/170,674, filed Jul. 10, 2008, which is hereby incorporated by reference herein in its entirety.

### TECHNICAL FIELD

The disclosed subject matter relates to systems, methods, and media for providing interactive video using scalable video coding.

### BACKGROUND

Digital video systems have become widely used for varying purposes ranging from entertainment to video conferencing. Many digital video systems require providing different video signals to different recipients. This can be a quite complex process.

For example, traditionally, when different content is desired to be provided to different recipients, a separate video encoder would need to be provided for each recipient. In this way, the video for that recipient would be encoded for that user by the corresponding encoder. Dedicated encoders for individual users may be prohibitively expensive, however, both in terms of processing power and bandwidth.

Similarly, in order to facilitate interactive video for an end-user, it is commonly required to use a different encoder for each state of the video. For example, this may be the case with real-time on-screen menus that may have different combinations of on-screen elements, close captions and translations that may be provided in different languages, Video On Demand (VOD) that can provide different levels of content, etc. In each of these types of products, an end user may desire to interactively switch the content that is being received, and hence change what content needs to be encoded for that user.

Accordingly, it is desirable to provide mechanisms for controlling video signals.

### SUMMARY

Systems, methods, and media for providing interactive video using scalable video coding are provided. In some embodiments, systems for providing interactive video using scalable video coding are provided, the systems comprising: at least one microprocessor programmed to at least: provide at least one scalable video coding capable encoder that at least: receives at least a base content sequence and a plurality of mutually exclusive added content sequences that have different content from the base content sequence; produces a first scalable video coding compliant stream that includes at least a basic layer, that corresponds to the base content sequence, and a first mutually exclusive enhancement layer, that corresponds to content in a first of the plurality of mutually exclusive added content sequences; and produces at least a second mutually exclusive enhancement layer, that corresponds to content in a second of the plurality of mutually exclusive added content sequences; and perform multiplexing of the first scalable video coding compliant stream and the second mutually exclusive enhancement layer to provide a second stream.

In some embodiments, methods for providing interactive video using scalable video coding are provided, the methods comprising: receiving at least a base content sequence and a plurality of mutually exclusive added content sequences that have different content from the base content sequence; producing a first scalable video coding compliant stream that includes at least a basic layer, that corresponds to the base content sequence, and a first mutually exclusive enhancement layer, that corresponds to content in a first of the plurality of mutually exclusive added content sequences; producing at least a second mutually exclusive enhancement layer, that corresponds to content in a second of the plurality of mutually exclusive added content sequences; and performing multiplexing of the first scalable video coding compliant stream and the second mutually exclusive enhancement layer to provide a second stream.

In some embodiments, computer-readable media encoded with computer-executable instructions that, when executed by a microprocessor programmed with the instructions, cause the microprocessor to perform a method for providing interactive video using scalable video coding are provided, the method comprising: receiving at least a base content sequence and a plurality of mutually exclusive added content sequences that have different content from the base content sequence; producing a first scalable video coding compliant stream that includes at least a basic layer, that corresponds to the base content sequence, and a first mutually exclusive enhancement layer, that corresponds to content in a first of the plurality of mutually exclusive added content sequences; producing at least a second mutually exclusive enhancement layer, that corresponds to content in a second of the plurality of mutually exclusive added content sequences; and performing multiplexing of the first scalable video coding compliant stream and the second mutually exclusive enhancement layer to provide a second stream

### BRIEF DESCRIPTION OF THE DRAWINGS

FIG. 1 is a diagram of signals provided to and received from an SVC-capable encoder in accordance with some embodiments of the disclosed subject matter.

FIG. 2a is a diagram of an SVC-capable encoder in accordance with some embodiments of the disclosed subject matter.

FIG. 2b is a diagram of another SVC-capable encoder in accordance with some embodiments of the disclosed subject matter.

FIG. 2c is a diagram of yet another SVC-capable encoder in accordance with some embodiments of the disclosed subject matter.

FIG. 3 is a diagram of a video distribution system in accordance with some embodiments of the disclosed subject matter.

FIG. 4a is a diagram illustrating the combination of basic and enhancement layers in accordance with some embodiments of the disclosed subject matter.

FIG. 4b is another diagram illustrating the combination of basic and enhancement layers in accordance with some embodiments of the disclosed subject matter.

FIG. 5 is a diagram of a video conferencing system in accordance with some embodiments of the disclosed subject matter.

FIG. 6 is a diagram of different user end point displays in accordance with some embodiments of the disclosed subject matter.

FIG. 7a is a diagram showing contents of two SVC streams and a non-SVC-compliant stream produced by multiplexing the two SVC streams in accordance with some embodiments of the disclosed subject matter.

FIG. 7b is a diagram of how the contents of the non-SVC-compliant stream of FIG. 7a can be used to create displays in accordance with some embodiments of the disclosed subject matter.

### DETAILED DESCRIPTION

Systems, methods, and media for providing interactive video using scalable video coding are provided. In accordance with various embodiments, two or more video signals can be provided to a scalable video coding (SVC)-capable encoder so that a basic layer and one or more enhancement layers are produced by the encoder. The basic layer can be used to provide base video content and the enhancement layer(s) can be used to modify that base video content with added video content. By controlling when the enhancement layer(s) are available (e.g., by concealing corresponding packets, by selecting corresponding packets, etc.), the availability of the added video content by a video display can be controlled.

A scalable video protocol may include any video compression protocol that allows decoding of different representations of video from data encoded using that protocol. The different representations of video may include different resolutions (spatial scalability), frame rates (temporal scalability), bit rates (SNR scalability), portions of content, and/or any other suitable characteristic. Different representations may be encoded in different subsets of the data, or may be encoded in the same subset of the data, in different embodiments. For example, some scalable video protocols may use layering that provides one or more representations (such as a high resolution image of a user, or an on-screen graphic) of a video signal in one layer and one or more other representations (such as a low resolution image of the user, or a non-graphic portion) of the video signal in another layer. As another example, some scalable video protocols may split up a data stream (e.g., in the form of packets) so that different representations of a video signal are found in different portions of the data stream. Examples of scalable video protocols may include the Scalable Video Coding (SVC) protocol defined by the Scalable Video Coding Extension of the H.264/AVC Standard (Annex G) from the International Telecommunication Union (ITU), the MPEG2 protocol defined by the Motion Picture Experts Group, the H.263 (Annex O) protocol from the ITU, and the MPEG4 part 2 FGS protocol from the Motion Picture Experts Group, each of which is hereby incorporated by reference herein in its entirety.

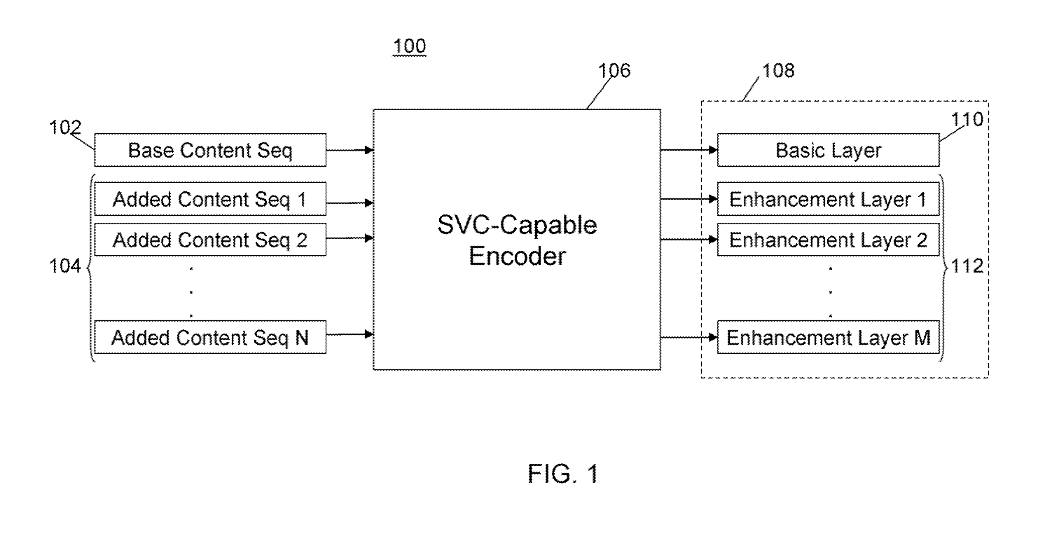

Turning to FIG. 1, an illustration of a generalized approach 100 to encoding video in some embodiments is provided. As shown, a base content sequence 102 can be supplied to an SVC-capable encoder 106. One or more added content sequences 1-N 104 can also be supplied to the SVC-capable encoder. In response to receiving these sequences, the encoder can then provide a stream 108 containing a basic layer 110 and one or more enhancement layers 112.

Base content sequence 102 can be any suitable video signal containing any suitable content. For example, in some embodiments, base content sequence can be video content that is fully or partially in a low-resolution format. This low-resolution video content may be suitable as a teaser to entice a viewer to purchase a higher resolution version of the content, as a more particular example. As another example, in some embodiments, base content sequence can be video content that is fully or partially distorted to prevent complete viewing of the video content. As another example, in some embodiments, base content sequence can be video content that is missing text (such as close captioning, translations, etc.) or graphics (such as logos, icons, advertisements, etc.) that may be desirable for some viewers.

Added content sequence(s) 104 can be any suitable content that provides a desired total content sequence. For example, when base content sequence 102 includes low-resolution content, added content sequence(s) 104 can be a higher resolution sequence of the same content. As another example, when base content sequence 102 is video content that is missing desired text or graphics, added content sequence(s) 104 can be the video content with the desired text or graphics.

Additionally or alternatively, in some embodiments, added content sequence(s) 104 can be any suitable content that provides a desired portion of a content sequence. For example, when a base content sequence 102 includes television program, added content sequences 104 can include close captioning content in different languages (e.g., one sequence 104 is English, one sequence 104 is in Spanish, etc.).

In some embodiments, the resolution and other parameters of the base content sequence and added content sequence(s) can be identical. In some embodiments, in case that added content is restricted to a small part of a display screen (e.g., as in the case of a logo or a caption), it may be beneficial to position the content in the added content sequence, so that is aligned to macro block (MB) boundaries. This may improve the visual quality of the one or more enhancements layers encoded by the SVC encoder.

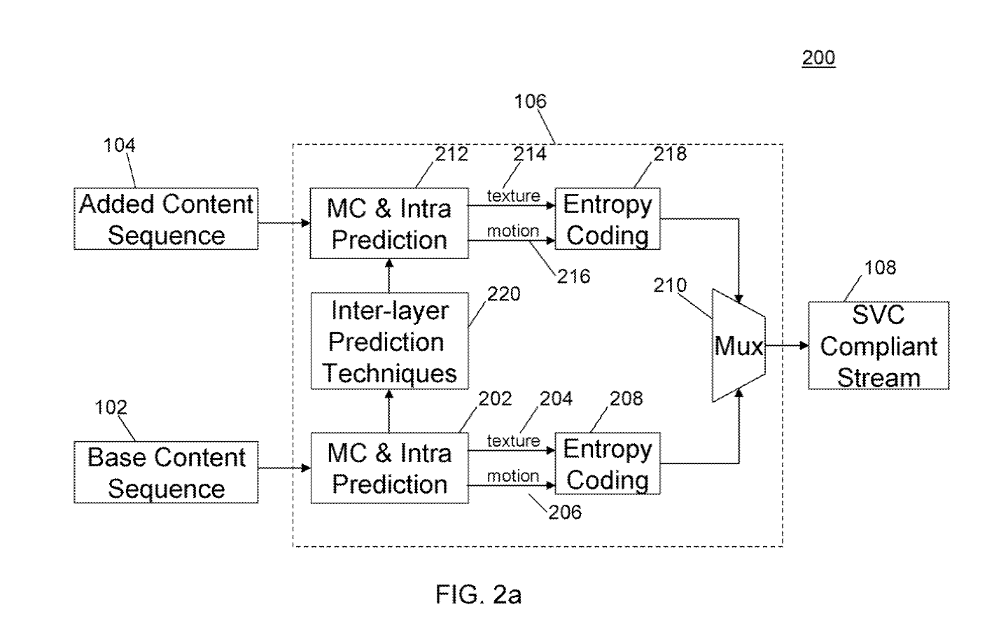

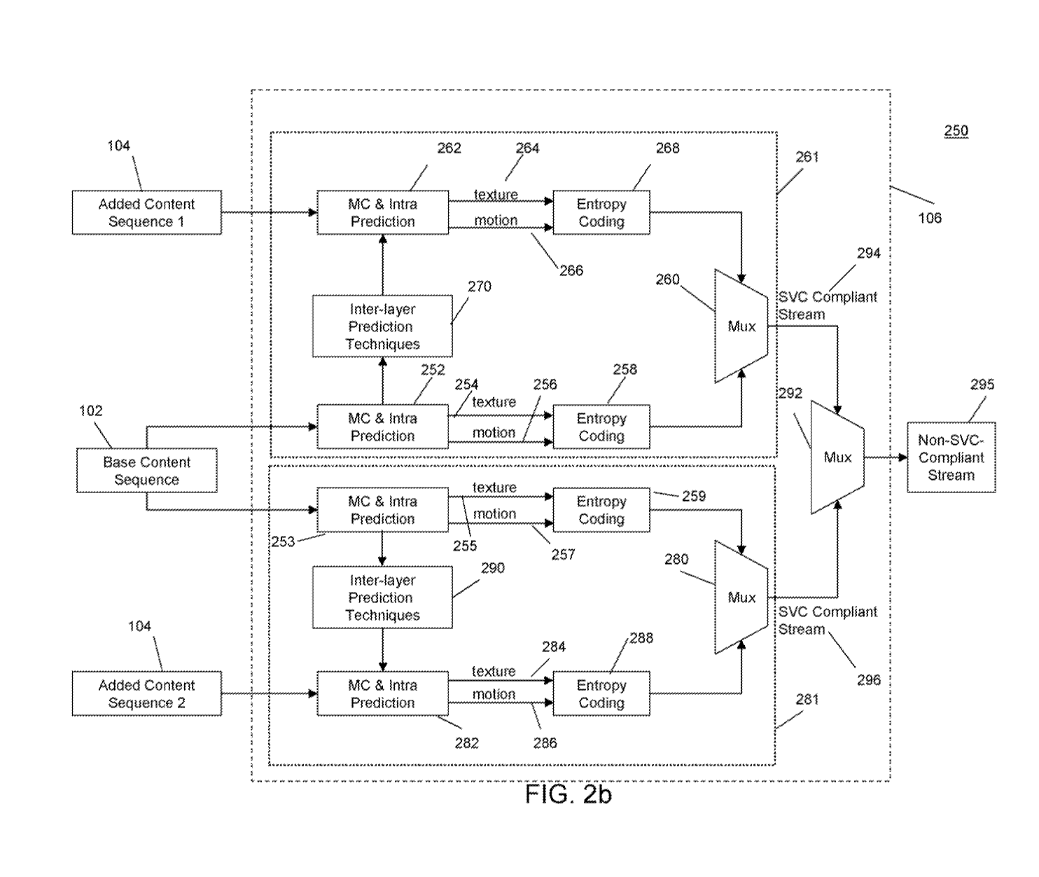

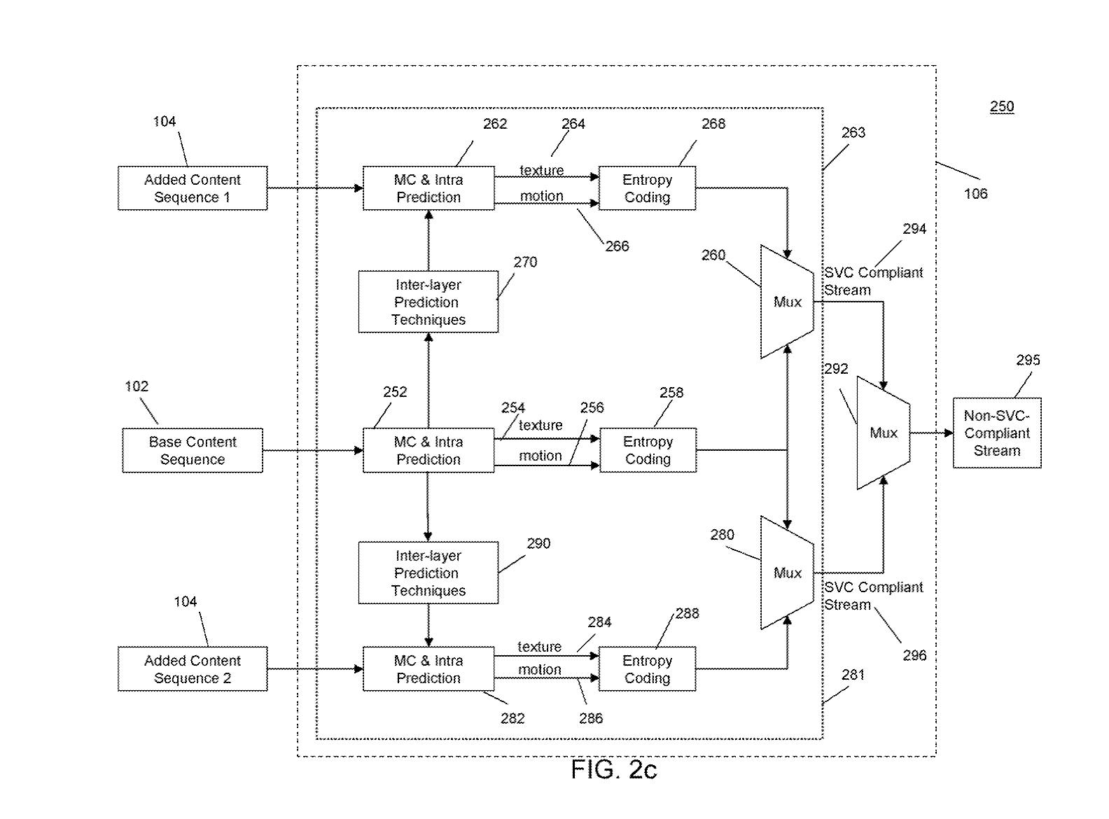

SVC-capable encoder 106 can be any suitable SVC-capable encoder for providing an SVC stream, or can include more than one SVC-capable encoders that each provide an SVC stream. For example, in some embodiments, SVC-capable encoder 106 can implement a layered approach (similar to Coarse Grained Scalability) in which two layers are defined (basic and enhancement), the spatial resolution factor is set to one, intra prediction is applied only to the basic layer, the quantization error between a low-quality sequence and a higher-quality sequence is encoded using residual coding, and motion data, up-sampling, and/or other trans-coding is not performed. As another example, SVC-capable encoder 106 (and sub-encoders 261 and 281 of FIG. 2b discussed below) can be implemented using the Joint Scalable Video Model (JSVM) software from the Scalable Video Coding (SVC) project of the Joint Video Team (JVT) of the ISO/TEC Moving Pictures Experts Group (MPEG) and the ITU-T Video Coding Experts Group (VCEG). Examples of configuration files for configuring the JSVM software are illustrated in the Appendix below. Any other suitable configuration for an SVC-capable encoder can additionally or alternatively be used.

Such an SVC encoder can be implemented in any suitable hardware in accordance with some embodiments. For example, such an SVC encoder can be implemented in a special purpose computer or a general purpose computer programmed to perform the functions of the SVC encoder. As another example, an SVC encoder can be implemented in dedicated hardware that is configured to provide such an encoder. This dedicated hardware can be part of a larger device or system, or can be the primary component of a device or system. Such a special purpose computer, general purpose computer, or dedicated hardware can be implemented using any suitable components. For example, these components can include a processor (such as a microprocessor, microcontroller, digital signal processor, programmable gate array, etc.), memory (such as random access memory, read only memory, flash memory, etc.), interfaces (such as computer network interfaces, etc.), displays, input devices (such as keyboards, pointing devices, etc.), etc.

As mentioned above, SVC-capable encoder 106 can provide SVC stream 108, which can include basic layer 110 and one or more enhancement layers 112. The basic layer, when decoded, can provide the signal in base content sequence 102. The one or more enhancement layers 112, when decoded, can provide any suitable content that, when combined with basic layer 110, can be used to provide a desired video content. Decoding of the SVC stream can be performed by any suitable SVC decoder, and the basic layer can be decoded by any suitable Advanced Video Coding (AVC) decoder in some embodiments.

While FIG. 1 illustrates a single SVC stream 108 with one basic layer 110 and one or more enhancement layers 112, in some embodiments multiple SVC streams 108 can be produced by SVC-capable encoder 106. For example, when three enhancement layers 112 are produced, three SVC streams 108 can be produced wherein each of the streams includes the basic layer and a respective one of the enhancement layers. As another example, when multiple SVC streams are produced, any one or more of the streams can include more than one enhancement layer in addition to a basic layer.

Turning to FIG. 2a, a more detailed illustration of an SVC-capable encoder 106 that can be used in some embodiments is provided. As shown, SVC-capable encoder 106 can receive a base content sequence 102 and an added-content sequence 104. The base content sequence 102 can then be processed by motion compensation and intra prediction mechanism 202. This mechanism can perform any suitable SVC motion compensation and intra prediction processes. A residual texture signal 204 (produced by motion compensation and intra prediction mechanism 202) may then be quantized and provided together with the motion signal 206 to entropy coding mechanism 208. Entropy coding mechanism 208 may then perform any suitable entropy coding function and provide the resulting signal to multiplexer 210.

Data from motion compensation and intra prediction process 202 can then be used by inter-layer prediction techniques 220, along with added content sequence 104, to drive motion compensation and prediction mechanism 212. Any suitable data from motion compensation and intra prediction mechanism 202 can be used. Any suitable SVC inter-layer prediction techniques 220 and any suitable SVC motion compensation and intra prediction processes in mechanism 212 can be used. A residual texture signal 214 (produced by motion compensation and intra prediction mechanisms 212) may then be quantized and provided together with the motion signal 216 to entropy coding mechanism 218. Entropy coding mechanism 218 may then perform any suitable entropy coding function and provide the resulting signal to multiplexer 210. Multiplexer 210 can then combine the resulting signals from entropy coding mechanisms 208 and 218 as an SVC compliant stream 108.

Side information can also be provided to encoder 106 in some embodiments. This side information can identify, for example, a region of an image where content corresponding to a difference between the base content sequence and an added content sequence is (e.g., where a logo or text may be located). In some embodiments, side information can additionally or alternatively identify the content (e.g., close caption data in English, close caption data in Spanish, etc.) that is in each enhancement layer. The side information can then be used in a mode decision step within block 212 to determine whether to process the added content sequence or not.

Turning to FIG. 2b, another more detailed illustration of an SVC-capable encoder 106 including two sub-encoders 261 and 281 that can be used in some embodiments is provided. As shown, SVC-capable encoder 106 can receive a base content sequence 102 and two added-content sequences 104 which are mutually exclusive because they contain content that will not be viewed at the same time. The base content sequence 102 can then be processed by motion compensation and intra prediction mechanisms 252 and 253. These mechanisms can perform any suitable SVC motion compensation and intra prediction processes. Residual texture signals 254 and 255 (produced by motion compensation and intra prediction mechanisms 252 and 253, respectively) may then be quantized and provided together with the motion signals 256 and 257 (respectively) to entropy coding mechanisms 258 and 259 (respectively). Entropy coding mechanisms 258 and 259 may then perform any suitable entropy coding function and provide the resulting signal to multiplexers 260 and 280.

Data from motion compensation and intra prediction processes 252 and 253 can then be used by inter-layer prediction techniques 270 and 290 (respectively), along with added content sequences 104, to drive motion compensation and prediction mechanisms 262 and 282 (respectively). Any suitable data from motion compensation and intra prediction mechanisms 252 and 253 can be used. Any suitable SVC inter-layer prediction techniques 270 and 290 and any suitable SVC motion compensation and intra prediction processes in mechanisms 262 and 282 can be used. Residual texture signals 264 and 284 (produced by motion compensation and intra prediction mechanisms 262 and 282, respectively) may then be quantized and provided together with the motion signals 266 and 286 to entropy coding mechanisms 268 and 288, respectively. Entropy coding mechanisms 268 and 288 may then perform any suitable entropy coding function and provide the resulting signal to multiplexers 260 and 280, respectively. Multiplexers 260 and 280 can then combine the resulting signals from entropy coding mechanisms 258 and 268 and entropy coding mechanisms 258 and 288 as SVC compliant streams 294 and 296. These SVC compliant streams can then be provided to multiplexer 292, which can produce a non-SVC compliant stream 295.

In some embodiments, rather than using two sub-encoders 261 and 281, as shown in FIG. 2c, a single encoder 263 can be provided in which motion compensation and intra prediction mechanisms 252 and 253 are the same mechanism (numbered as 252) and entropy coding mechanisms 258 and 259 are the same mechanism (numbered as 258).

In some embodiments, the quantization levels used by motion compensation and intra prediction mechanisms 252, 253, 262, and 282 are all identical.

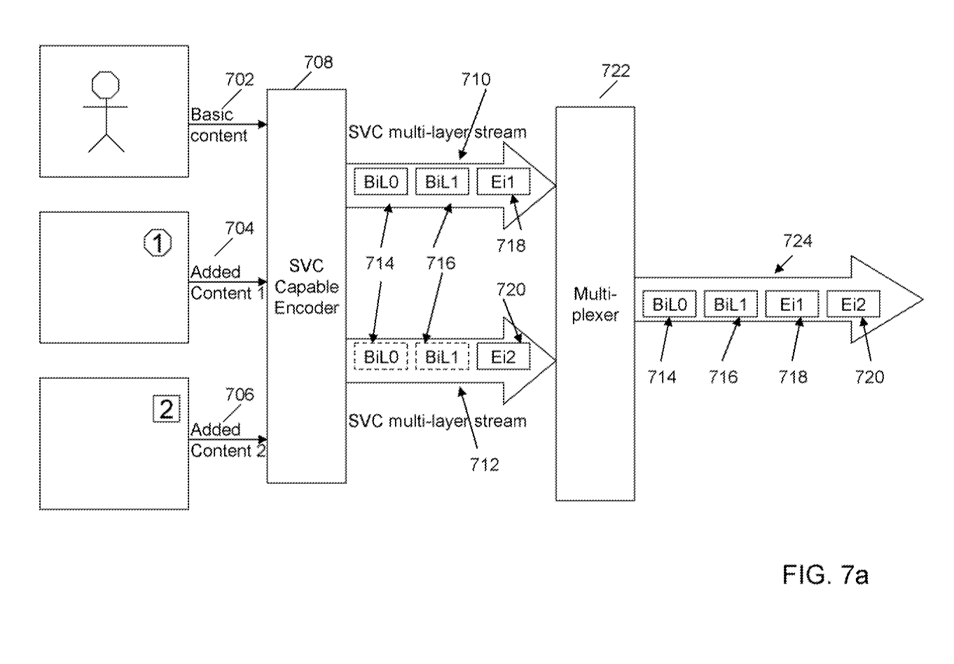

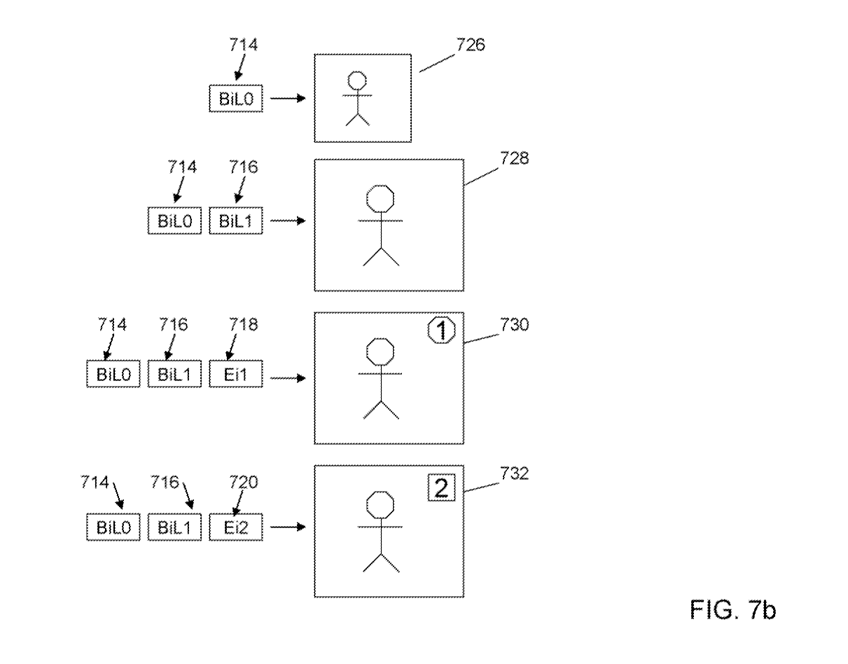

In some embodiments, multiplexer 292 can include a mechanism to prevent duplicate base content from streams 294 or 296 from being in stream 295 as described further in connection with FIG. 7a below.

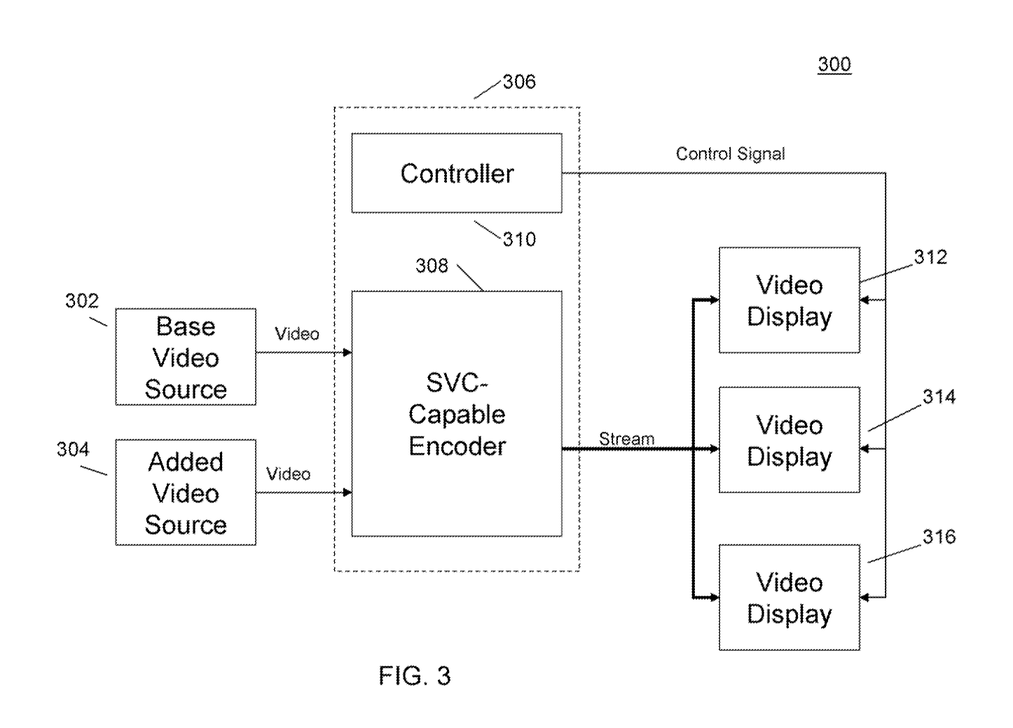

FIG. 3 illustrates an example of a video distribution system 300 in accordance with some embodiments. As shown, a distribution controller 306 can receive a base content sequence as video from a base video source 302 and an added content sequence as video from an added video source 304. These sequences can be provided to an SVC-capable encoder 308 that is part of distribution controller 306. The SVC capable encoder 308 can then produce a stream that includes a base layer and at least one enhancement layer as described above, and provides this stream to one or more video displays 312, 314, and 316. The distribution controller can also include a controller 310 that provides control signal to the one or more video displays 312, 314, and 316. This control signal can indicate what added content (if any) a video display is to display. Additionally or alternatively to using a controller 310 that is part of controller 306 and is coupled to displays 312, 314, and 316, in some embodiments, a separate component (e.g., such as a network component such as a router, gateway, etc.) may be provided between encoder 308 and displays 312, 314 and 316 that contains a controller (like controller 310 for example) that determines what portions (e.g., layers) of the SVC stream can pass through to displays 312, 314, and 316.

Controller 310, or a similar mechanism in a network component, display, endpoint, etc., may use any suitable software and/or hardware to control which enhancement layers are presented and/or which packets of an SVC stream are concealed. For example, these devices may include a digital processing device that may include one or more of a microprocessor, a processor, a controller, a microcontroller, a programmable logic device, and/or any other suitable hardware and/or software for controlling which enhancement layers are presented and/or which packets of an SVC stream are concealed.

In some embodiments, controller 310 can be omitted.

Such a video distribution system, as described in connection with FIG. 3, can be part of any suitable video distribution system. For example, in some embodiments, the video distribution system can be part of a video conferencing system, a streaming video system, a television system, a cable system, a satellite system, a telephone system, etc.

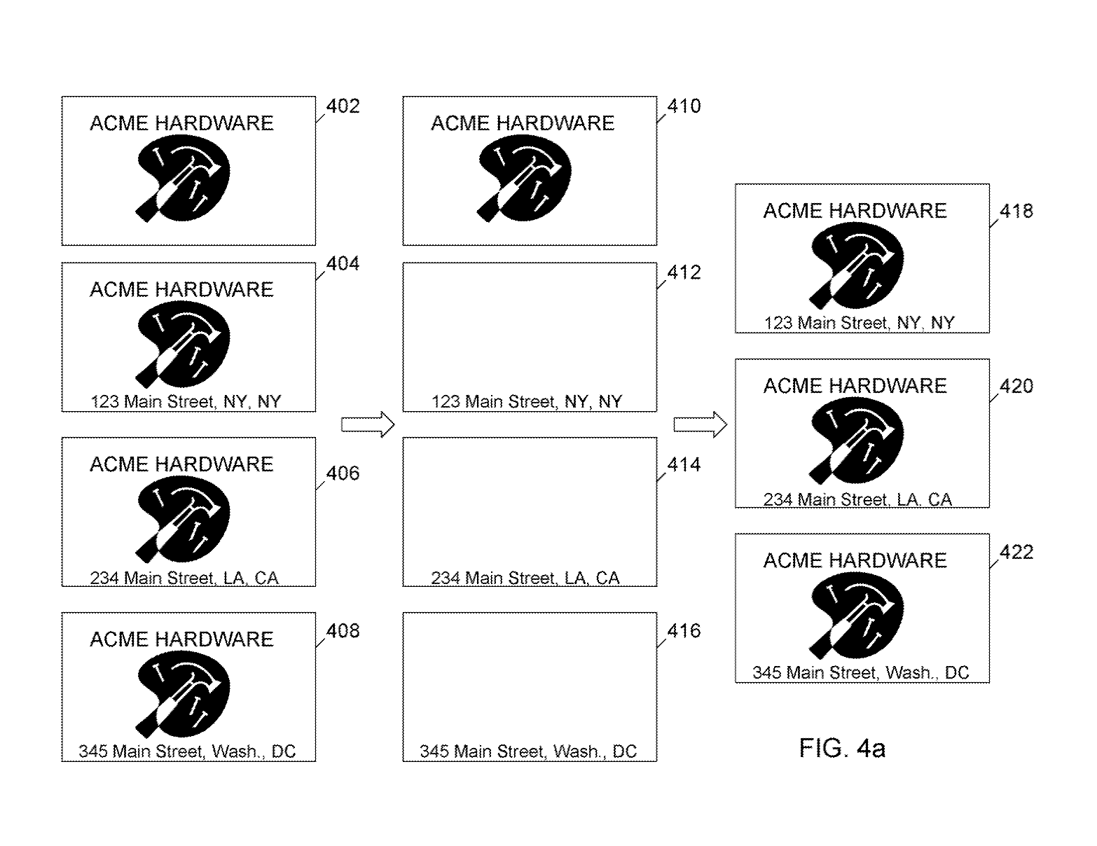

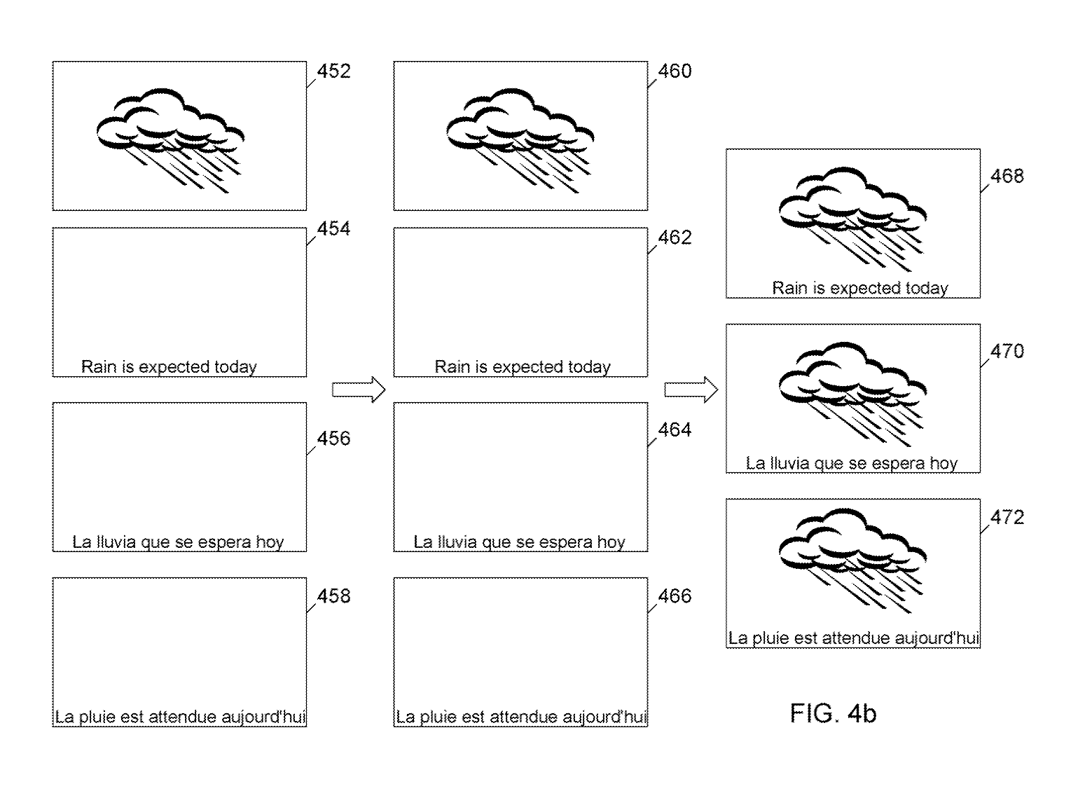

Turning to FIG. 4a, an example of how such a distribution system may be used in some embodiments is shown. As illustrated, a base content sequence 402 and three added content sequences 404, 406, and 408 may be provided to encoder 308. The encoder may then produce basic layer 410 and enhancement layers 412, 414, and 416. These layers may then be formed into three SVC streams: one with layers 410 and 412; another with layers 410 and 414; and yet another with layers 410 and 416. Each of the three SVC streams may be addressed to a different one of video display 312, 314, and 316 and presented as shown in displays 418, 420, and 422, respectively.

Additionally or alternatively to providing three SVC streams, a single stream may be generated and only selected portions (e.g., packets) utilized at each of video displays 312, 314, and 316. The selection of portions may be performed at the displays or at a component between the encoder and the displays as described above in some embodiments.

Turning to FIG. 4b, another example of how such a distribution system may be used in some embodiments is shown. As illustrated, a base content sequence 452 and three mutually exclusive added content sequences 454, 456, and 458 in English, Spanish, and French may be provided to encoder 308. The encoder may then produce basic layer 460 and mutually exclusive enhancement layers 462, 464, and 466. These layers may then be multiplexed into a non-SVC compliant stream and provided to all of displays 312, 314, and 316. In some embodiments, the enhancement layers 462, 464, and 466 can be provided with identifiers (e.g., such as a unique identification number) to assist in their subsequent selection. Based on an internal selection mechanism in displays 312, 314, and/or 316, combinations of the layers may be presented as shown in displays 468, 470, and 472 to provide English, Spanish, and French close captioning. In some embodiments, a user at display 312, 314, or 316 can choose which combination of layers to view—that is, with the English, Spanish, or French close captioning—and the user can switch which combination of layers are being viewed on demand.

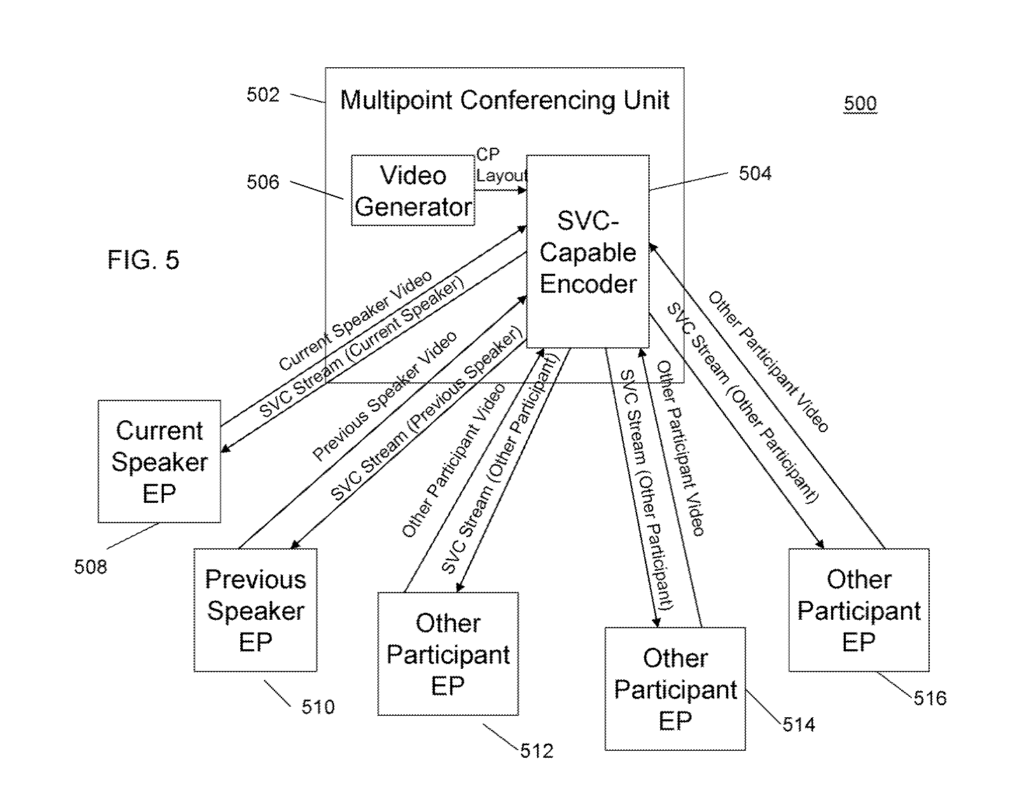

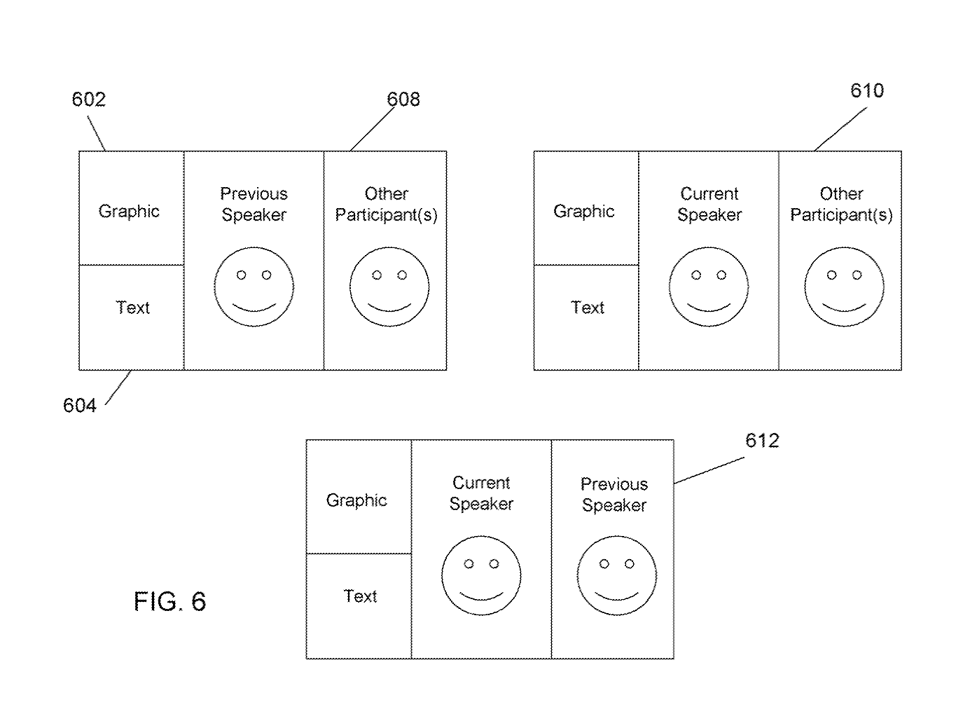

FIGS. 5 and 6 illustrate a video conferencing system 500 in accordance with some embodiments. As shown, system 500 includes a multipoint conferencing unit (MCU) 502.

MCU 502 can include an SVC-capable encoder 504 and a video generator 506. Video generator 506 may generate a continuous presence (CP) layout in any suitable fashion and provide this layout as a base content sequence to SVC-capable encoder 504. The SVC capable encoder may also receive as added content sequences current speaker video, previous speaker video, and other participant video from current speaker end point 508, previous speaker end point 510, and other participant end points 512, 514, and 516, respectively. SVC streams can then be provided from encoder 504 to current speaker end point 508, previous speaker end point 510, and other participant end points 512, 514, and 516 and be controlled as described below in connection with FIG. 6.

As illustrated in FIG. 6, the display on current speaker end point 508 may be controlled so that the user sees a CP layout from the basic layer (which may include graphics 602 and text 604) along with enhancement layers corresponding to the previous speaker and one or more of the other participants, as shown in display 608. The display on previous speaker end point 510 may be controlled so that the user sees a CP layout from the basic layer along with enhancement layers corresponding to the current speaker and one or more of the other participants, as shown in display 610. The display on other participant end points 512, 514, and 516 may be controlled so that the user sees a CP layout from the basic layer along with enhancement layers corresponding to the current speaker and the previous speaker, as shown in display 612. In this way, no user of an endpoint sees video of himself or herself.

Although FIG. 5 illustrates different SVC streams going from the SVC-capable encoder to endpoints 508, 510, and 512, 514, and 516, in some embodiments, these streams may all be identical and a separate control signal (not shown) for selecting which enhancement layers are presented on each end point may be provided. Additionally or alternatively, the SVC-capable encoder or any other suitable component may select to provide only certain enhancement layers as part of SVC stream based on the destination for the streams using packet concealment or any other suitable technique.

Turning to FIGS. 7a and 7b, another example of how basic content and added content can be processed to provide a stream for producing different video displays in accordance with some embodiments is illustrated. As shown in FIG. 7a, basic content 702, added content 1 704, and added content 2 706 can be provided to an SVC capable encoder 708. SVC capable encoder 708 can then produce an SVC stream 710 and an SVC stream 712. SVC stream 710 can include basic layer 0 714, basic layer 1 716, and enhancement layer 1 718. SVC stream 712 can include basic layer 0 714, basic layer 1 716, and enhancement layer 2 720. Streams 710 and 712 can be provided to multiplexer 722, which can then produce non-SVC-compliant stream 724. Stream 724 can include basic layer 0 714, basic layer 1 716, enhancement layer 1 718, and enhancement layer 2 720. As can be seen, stream 724 can be produced in such a way in which the redundant layers between streams 710 and 712 are eliminated.

As shown in FIG. 7b, a first video display 726 can be provided by basic layer 0 714. This display may be, for example, a low resolution or small version of a base image. A second video display 728 can be provided by the combination of basic layer 0 714 and basic layer 1 716. This display may be, for example, a higher resolution or larger version of the base image. A third video display 730 can be provided by basic layer 0 714, basic layer 1 716, and enhancement layer 1 718. This display may be, for example, a higher resolution or larger version of the base image along with a first graphic. A fourth video display 732 can be provided by basic layer 0 714, basic layer 1 716, and enhancement layer 2 720. This display may be, for example, a higher resolution or larger version of the base image along with a second graphic.

In some embodiments, any suitable computer readable media can be used for storing instructions for performing the functions described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

### APPENDIX

An example of a “encoder.cfg” configuration file that may be used with a JSVM 9.1 encoder in some embodiments is shown below:

# Scalable H.264/AVC Extension Configuration File
#============================== GENERAL ==============================

| | | |
|---|---|---|
| OutputFile | test.264 | # Bitstream file |
| FrameRate | 30 | # Maximum frame rate [Hz] |
| MaxDelay | 0 | # Maximum structural delay [ms] |
| | | # (required for interactive |
| | | # communication) |
| FramesToBeEncoded | 30 | # Number of frames (at input frame rate) |
| CgsSnrRefinement | 1 | # (0:SNR layers as CGS, 1:SNR layers |
| | | # as MGS) |
| EncodeKeyPictures | 1 | # key pictures at temp. level 0 |
| | | # [0:FGS only, 1:FGS&MGS, |
| | | # 2:always(useless)] |
| MGSControl | 1 | # (0:ME+MC using current layer, |
| | | # 1:ME using EL ref. pics, 2:ME+MC |
| | | # using EL ref. pics) |
| MGSKeyPicMotRef | 1 | # motion refinement for MGS key pics |
| | | # (0:off, 1:one) |

#============================== MCTF ==============================

| | | |
|---|---|---|
| GOPSize | 1 | # GOP Size (at maximum frame rate) (no |
| | | # temporal scalability) |
| IntraPeriod | −1 | # Intra Period |
| NumberReferenceFrames | 1 | # Number of reference pictures |
| BaseLayerMode | 1 | # Base layer mode (0:AVC w large DPB, |
| | | # 1:AVC compatible, 2:AVC w subseq |
| | | # SEI) |

#============================== MOTION SEARCH =======================

| | | |
|---|---|---|
| SearchMode | 4 | # Search mode (0:BlockSearch, |
| | | # 4:FastSearch) |
| SearchFuncFullPel | 0 | # Search function full pel |
| | | # (0:SAD, 1:SSE, 2:HADAMARD, 3:SAD- |
| | | # YUV) |
| SearchFuncSubPel | 0 | # Search function sub pel |
| | | # (0:SAD, 1:SSE, 2:HADAMARD) |
| SearchRange | 16 | # Search range (Full Pel) |
| BiPredIter | 2 | # Max iterations for bi-pred search |
| IterSearchRange | 2 | # Search range for iterations (0: |
| | | # normal) |

#============================== LOOP FILTER ===========================

| | | |
|---|---|---|
| LoopFilterDisable | 0 | # Loop filter idc (0: on, 1: off, 2: |
| | | # on except for slice boundaries) |
| LoopFilterAlphaC0Offset | 0 | # AlphaOffset(−6..+6): valid range |
| LoopFilterBetaOffset | 0 | # BetaOffset (−6..+6): valid range |

#============================== LAYER DEFINITION ======================

| | | |
|---|---|---|
| NumLayers | 2 | # Number of layers |
| LayerCfg | base_content.cfg | # Layer configuration file |
| LayerCfg | added_content.cfg | # Layer configuration file |

| #LayerCfg | ..\..\..\data\layer2.cfg | # Layer configuration file |
|---|---|---|
| #LayerCfg | ..\..\..\data\layer3.cfg | # Layer configuration file |
| #LayerCfg | ..\..\..\data\layer4.cfg | # Layer configuration file |
| #LayerCfg | layer5.cfg # Layer configuration file | |
| #LayerCfg | layer6.cfg # Layer configuration file | |
| #LayerCfg | ..\..\..\data\layer7.cfg | # Layer configuration file |

| | | |
|---|---|---|
| PreAndSuffixUnitEnable | 1 | # Add prefix and suffix unit (0: off, |
| | | # 1: on) shall always be on in SVC |
| | | # contexts (i.e. when there are |
| | | # FGS/CGS/spatial enhancement layers) |
| MMCOBaseEnable | 1 | # MMCO for base representation (0: off, |
| | | # 1: on) |
| TLNestingFlag | 0 | # Sets the temporal level nesting flag |
| (0: off, 1: on) | | |
| TLPicIdxEnable | 0 | # Add picture index for the lowest |

temporal level (0: off, 1: on)
#============================== RCDO ================================

| | | |
|---|---|---|
| RCDOBlockSizes | 1 | # restrict block sizes for MC |
| | | # (0:off, 1:in EL, 2:in all layers) |
| RCDOMotionCompensationY | 1 | # simplified MC for luma |
| | | # (0:off, 1:in EL, 2:in all layers) |
| RCDOMotionCompensationC | 1 | # simplified MC for chroma |
| | | # (0:off, 1:in EL, 2:in all layers) |
| RCDODeblocking | 1 | # simplified deblocking |
| | | # (0:off, 1:in EL, 2:in all layers) |

#=============================== HRD ==================================

| | |
|---|---|
| EnableNalHRD | 0 |
| EnableVclHRD | 0 |

An example of a “base_content.cfg” configuration file (as referenced in the “encoder.cfg” file) that may be used with a JSVM 9.1 encoder in some embodiments is shown below:

# Layer Configuration File
#============================== INPUT / OUTPUT ========================

| | | |
|---|---|---|
| SourceWidth | 352 | # Input frame width |
| SourceHeight | 288 | # Input frame height |
| FrameRateIn | 30 | # Input frame rate [Hz] |
| FrameRateOut | 30 | # Output frame rate [Hz] |
| InputFile | base_content.yuv | # Input file |
| ReconFile | rec_layer0.yuv | # Reconstructed file |
| SymbolMode | 0 | # 0=CAVLC, 1=CABAC |

#============================== CODING ==============================

| | | |
|---|---|---|
| ClosedLoop | 1 | # Closed-loop control |
| | | # (0,1:at H rate, 2: at L+H rate) |
| FRExt | 0 | # FREXT mode (0:off, 1:on) |
| MaxDeltaQP | 0 | # Max. absolute delta QP |
| QP | 32.0 | # Quantization parameters |
| NumFGSLayers | 0 | # Number of FGS layers |
| | | # ( 1 layer − ~ delta QP = 6 ) |
| FGSMotion | 0 | # motion refinement in FGS layers |
| (0:off, 1:on) | | |

#============================== CONTROL ==============================

| | | |
|---|---|---|
| MeQP0 | 32.00 | # QP for motion estimation / mode decision (stage 0) |
| MeQP1 | 32.00 | # QP for motion estimation / mode decision (stage 1) |
| MeQP2 | 32.00 | # QP for motion estimation / mode decision (stage 2) |
| MeQP3 | 32.00 | # QP for motion estimation / mode decision (stage 3) |
| MeQP4 | 32.00 | # QP for motion estimation / mode decision (stage 4) |
| MeQP5 | 32.00 | # QP for motion estimation / mode decision (stage 5) |
| InterLayerPred | 0 | # Inter-layer Prediction (0: no, 1: yes, 2:adaptive) |
| BaseQuality | 3 | # Base quality level (0, 1, 2, 3) (0: no, 3, all) |

An example of a “added_content.cfg” configuration file (as referenced in the “encoder.cfg” file) that may be used with a JSVM 9.1 encoder in some embodiments is shown below:

# Layer Configuration File
#============================== INPUT / OUTPUT ========================

| | | |
|---|---|---|
| SourceWidth | 352 | # Input frame width |
| SourceHeight | 288 | # Input frame height |
| FrameRateIn | 30 | # Input frame rate [Hz] |
| FrameRateOut | 30 | # Output frame rate [Hz] |
| InputFile | added_content.yuv | # Input file |
| ReconFile | rec_layer0.yuv | # Reconstructed file |
| SymbolMode | 0 | # 0=CAVLC, 1=CABAC |

#============================== CODING ==============================

| | | |
|---|---|---|
| ClosedLoop | 1 | # Closed-loop control (0,1:at H rate, 2: at L+H rate) |
| FRExt | 0 | # FREXT mode (0:off, 1:on) |
| MaxDeltaQP | 0 | # Max. absolute delta QP |
| QP | 32.0 | # Quantization parameters |
| NumFGSLayers | 0 | # Number of FGS layers ( 1 layer − ~ delta QP = 6 ) |
| FGSMotion | 0 | # motion refinement in FGS layers (0:off, 1:on) |

#============================== CONTROL ==============================

| | | |
|---|---|---|
| MeQP0 | 32.00 | # QP for motion estimation / mode decision (stage 0) |
| MeQP1 | 32.00 | # QP for motion estimation / mode decision (stage 1) |
| MeQP2 | 32.00 | # QP for motion estimation / mode decision (stage 2) |
| MeQP3 | 32.00 | # QP for motion estimation / mode decision (stage 3) |
| MeQP4 | 32.00 | # QP for motion estimation / mode decision (stage 4) |
| MeQP5 | 32.00 | # QP for motion estimation / mode decision (stage 5) |
| InterLayerPred | 0 | # Inter-layer Prediction (0: no, 1: yes, 2:adaptive) |
| BaseQuality | 3 | # Base quality level (0, 1, 2, 3) (0: no, 3, all) |

What is claimed is:

1. A system for providing interactive video using scalable video coding, comprising:
at least one microprocessor programmed to at least:
provide at least one scalable video coding capable encoder that at least:
receives at least a base content sequence and a plurality of mutually exclusive added content sequences that have different content from the base content sequence;
produces a first scalable video coding compliant stream that includes at least a basic layer, that corresponds to the base content sequence, and a first mutually exclusive enhancement layer, that corresponds to content in a first of the plurality of mutually exclusive added content sequences; and
produces at least a second mutually exclusive enhancement layer, that corresponds to content in a second of the plurality of mutually exclusive added content sequences; and
perform multiplexing of the first scalable video coding compliant stream and the second mutually exclusive enhancement layer to provide a second stream.

2. The system of claim 1, further comprising a decoder that receives, demultiplexes, and decodes at least a portion of the second stream.

3. The system of claim 2, wherein the decoder includes a decoder that complies with the Scalable Video Coding Extension of the H.264/AVC Standard.

4. The system of claim 1, wherein the plurality of mutually exclusive added content sequences include text.

5. The system of claim 1, wherein the plurality of mutually exclusive added content sequences include graphics.

6. The system of claim 1, wherein the plurality of mutually exclusive added content sequences include video.

7. The system of claim 1, wherein the multiplexing is performed such that redundant data is prevented from being in the second stream.

8. A method for providing interactive video using scalable video coding, comprising:
receiving at least a base content sequence and a plurality of mutually exclusive added content sequences that have different content from the base content sequence;
producing a first scalable video coding compliant stream that includes at least a basic layer, that corresponds to the base content sequence, and a first mutually exclusive enhancement layer, that corresponds to content in a first of the plurality of mutually exclusive added content sequences;
producing at least a second mutually exclusive enhancement layer, that corresponds to content in a second of the plurality of mutually exclusive added content sequences; and
performing multiplexing of the first scalable video coding compliant stream and the second mutually exclusive enhancement layer to provide a second stream.

9. The method of claim 8, further comprising receiving, demultiplexing, and decoding at least a portion of the second stream.

10. The method of claim 9, wherein the decoding is performed in compliance with the Scalable Video Coding Extension of the H.264/AVC Standard.

11. The method of claim 8, wherein the plurality of mutually exclusive added content sequences include text.

12. The method of claim 8, wherein the plurality of mutually exclusive added content sequences include graphics.

13. The method of claim 8, wherein the plurality of mutually exclusive added content sequences include video.

14. The method of claim 8, wherein the multiplexing is performed such that redundant data is prevented from being in the second stream.

15. A computer-readable medium encoded with computer-executable instructions that, when executed by a microprocessor programmed with the instructions, cause the microprocessor to perform a method for providing interactive video using scalable video coding, the method comprising:
receiving at least a base content sequence and a plurality of mutually exclusive added content sequences that have different content from the base content sequence;
producing a first scalable video coding compliant stream that includes at least a basic layer, that corresponds to the base content sequence, and a first mutually exclusive enhancement layer, that corresponds to content in a first of the plurality of mutually exclusive added content sequences;
producing at least a second mutually exclusive enhancement layer, that corresponds to content in a second of the plurality of mutually exclusive added content sequences; and
performing multiplexing of the first scalable video coding compliant stream and the second mutually exclusive enhancement layer to provide a second stream.

16. The medium of claim 15, wherein the method further comprises receiving, demultiplexing, and decoding at least a portion of the second stream.

17. The medium of claim 16, wherein the decoding is performed in compliance with the Scalable Video Coding Extension of the H.264/AVC Standard.

18. The medium of claim 15, wherein the plurality of mutually exclusive added content sequences include text.

19. The medium of claim 15, wherein the plurality of mutually exclusive added content sequences include graphics.

20. The medium of claim 15, wherein the plurality of mutually exclusive added content sequences include video.

21. The medium of claim 15, wherein the multiplexing is performed such that redundant data is prevented from being in the second stream.
